(19) United States
(12) Patent Application Publication
(10) Pub. No.: US 2003/0019900 A1
(43) Pub. Date: Jan. 30, 2003

(54) Pill splitter

(76) Inventor: Charles S. Dienst, San Francisco, CA (US)

Correspondence Address: Jeffrey Jacobs, McCutchen, Doyle, Brown & Enersen, LLP, 28th Floor, Three Embarcadero Center, San Francisco, CA, 94111, US

(21) Appl. No.: 09/912,830

(22) Filed: Jul. 25, 2001

(51) Int. Cl. B26F 3/04

(52) U.S. Cl. 225/104; 225/103

(57) ABSTRACT

A pill splitting device is provided. The device may be comprised of a first portion hingeably coupled to a second portion. The lower portion includes a storage area and a pill holding region. The upper portion includes a cutting member located such that when the upper and lower portions are placed in a closed position, a pill within the pill holding region is split. In one aspect of the device, one or more surfaces of the pill holding region are coated with an elastomer, the elastomer enhancing the pill holding aspects of the device. In another aspect of the device, one or more surfaces of the pill holding region are grooved or ridged, the grooves or ridges enhancing the pill holding aspects of the device. In another aspect of the device, the upper, the lower, or both the upper and lower portions of the device are fabricated from transparent or semi-transparent material, thus allowing a user to monitor the pill cutting process and to potentially avoid situations in which the pill moves prior to being cut. In another aspect of the device, a magnifying lens element is included in the upper portion, thus allowing a user to more easily monitor the pill cutting process.

### FIELD OF THE INVENTION

The present invention relates generally to medicine and, more particularly, to an apparatus for use with medicines that are packaged as pills or tablets.

### BACKGROUND OF THE INVENTION

A variety of problems surround the use and delivery of medicine, in particular, medicines that are packaged as a pill or tablet and as such are provided in predetermined dosages. Often the dosage desired by the patient or intended by the attending physician is less than that which is available in pre-packaged form, thus requiring the patient, the patient's caretaker, or other party to divide the pill or tablet into one or more portions. Alternately, the pharmaceutical company may provide the pill or tablet in two dosages (e.g., 50 and 100 milligrams), but price the drugs similarly. Thus it is economically advantageous to purchase the larger dosage and divide it into smaller dosages.

Anticipating that the user may wish to divide a pill into smaller dosages, some pills are provided with a diametrical score mark that facilitates dividing the pill in half.

Regardless of whether a pill includes a score mark or not, dividing the pill into smaller portions is often difficult. The difficulty may arise from the inability of the user to apply sufficient force to break the pill into pieces by holding the small edges of the pill. As a consequence, some users resort to the use of some form of a cutting tool, typically a kitchen knife. Unfortunately this approach may lead to the edges of the pill crumbling, thus leading to wasted medicine and incorrect or undesired dosage levels. These problems may be compounded by the condition of the user, for example conditions such as the lack of muscle strength or control brought on by the user's age or infirmity.

In order to overcome the problems associated with splitting pills or tablets, a number of devices have been designed that aid the patient or user in this process. Unfortunately, these devices often block the user's view during the actual cutting process. Due to the lack of visibility, the pill may move prior to being cut, thus leading to incorrect apportiomnent of the medicine into the separate portions, and thus potentially misdosage of the patient. Additionally, some of these devices may not firmly grasp the pill, thus allowing pill slippage during the cutting process.

### SUMMARY OF THE INVENTION

A pill splitting device is provided. The device may be comprised of a first member hingeably coupled to a second member. The lower member includes a storage area and a pill holding region. The upper member includes a cutting member located such that when the upper and lower members are placed in a closed position, a pill within the pill holding region is split.

In one aspect of the device, one or more surfaces of the pill holding region are coated with an elastomer, the elastomer enhancing the pill holding aspects of the device.

In another aspect of the device, one or more surfaces of the pill holding region are grooved or ridged, the grooves or ridges enhancing the pill holding aspects of the device.

In yet another aspect of the device, the upper, the lower, or both the upper and lower members of the device are fabricated from transparent or semi-transparent material, thus allowing a user to monitor the pill cutting process and to potentially avoid situations in which the pill moves prior to being cut.

In yet another aspect of the device, a magnifying lens element is included in the upper member, thus allowing a user to more easily monitor the pill cutting process.

A further understanding of the nature and advantages of the present invention may be realized by reference to the remaining portions of the specification and the drawings.

### BRIEF DESCRIPTION OF THE DRAWINGS

FIG. 1 is a cross-sectional view of one embodiment of the invention;

FIG. 2 is a cross-sectional view of the same embodiment of the invention shown in FIG. 1 with the addition of the cutting blade;

FIG. 3 is a cross-sectional view of the same embodiment of the invention shown in FIG. 2 in an open position; and

FIG. 4 is a perspective view of the bottom portion of the preferred embodiment of the invention; and

FIG. 5 illustrates a pill inserted into the bottom portion of the preferred embodiment of the invention in readiness for the cutting operation.

### DESCRIPTION OF THE SPECIFIC EMBODIMENTS

It should be understood that the term “pill” as used herein refers to pills, tablets, caplets, or any other generally divisible, solid medicine that is consumed by a patient by either swallowing or chewing.

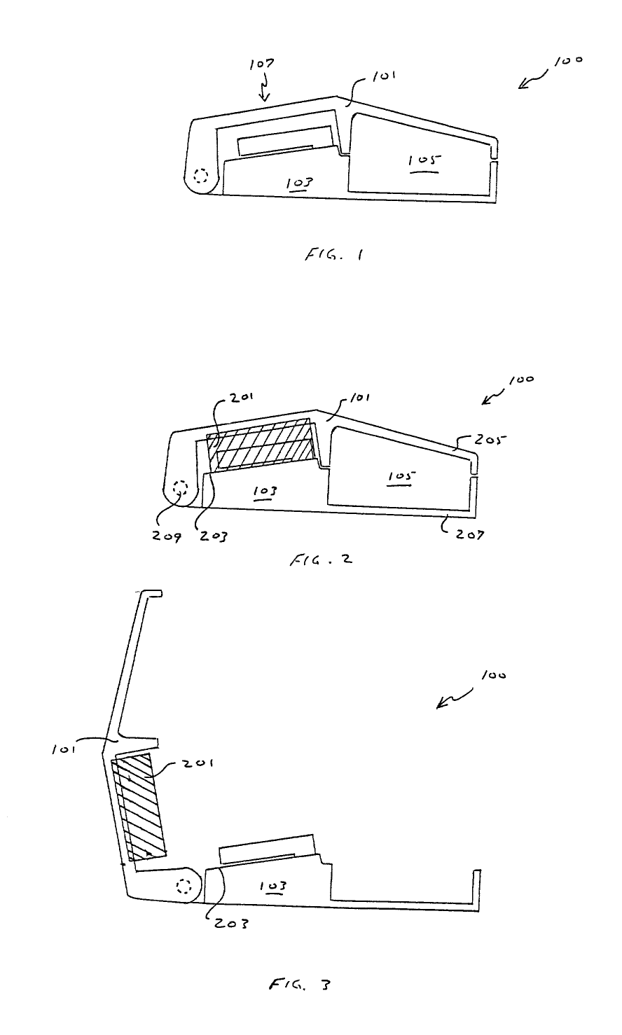

FIG. 1 is a cross-sectional view of a pill splitting device 100 in accordance with one embodiment of the invention. Pill splitting device 100 is comprised of an upper portion 101 hingeably coupled to a lower portion 103. When the two portions are in a closed position as shown in FIG. 1, device 100 includes a pill holding region 105 and a pill cutting region 107.

As shown in FIG. 2, pill cutting region 107 includes a cutting member 201 (not shown in FIG. 1). When the device is in the closed position, as shown, the edge of cutting member 201 rests against, or comes into close proximity to, surface 203 of lower portion 103. Cutting member 201 is preferably fabricated from metal and includes a knife edge or razor edge for the cutting edge. Portion 101 may be fabricated as a single piece, including cutting member 201. Alternately, cutting member 201 may be fabricated separately and inserted into portion 101 during the production of portion 101. Alternately, cutting member 201 may be bonded or otherwise affixed to portion 101 after the fabrication of portion 101 is complete. Portions 101 and 103 can be fabricated from a plastic, for example a thermoplastic or a thermosetting plastic, and are preferably fabricated from a polycarbonate.

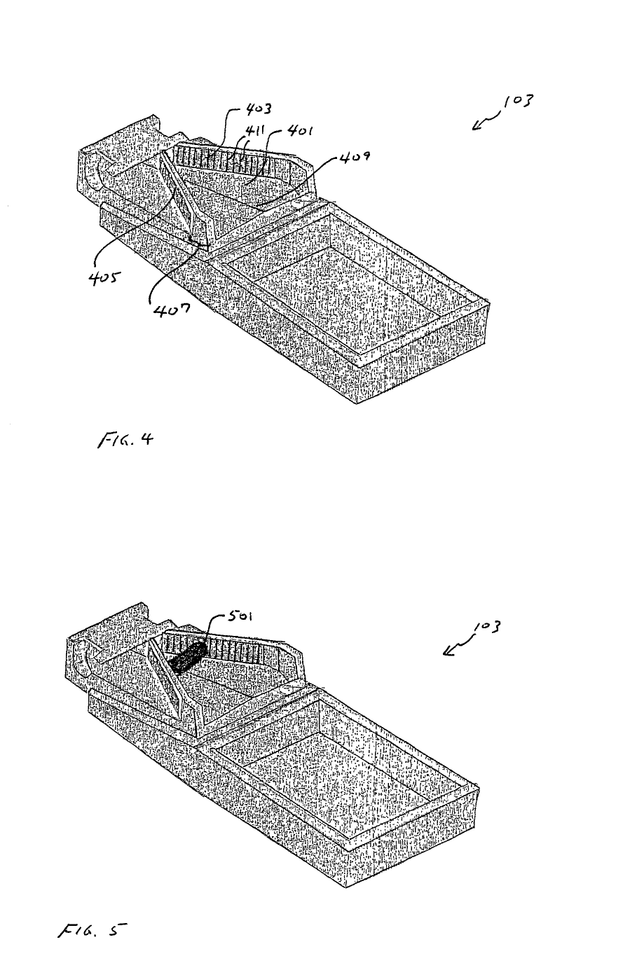

FIG. 3 is an illustration of device 100 in an open position. As is evident by comparing FIGS. 2 and 3, if a pill (not shown) is positioned on surface 203 when device 100 is open, closing the device results in the edge of cutting member 201 cutting the pill into two portions. As the pill will typically break into two portions prior to the complete closure of the device, the edge of cutting member 201 need not come into contact with surface 203 for the device to operate.

In use, the user opens device 100, places a pill on surface 203, and then closes the device, applying pressure to regions 205 and 207. Due to the location of cutting region 107 near hinge member 209 and due to the pivot point of hinge member 209 being located at the opposite end of device 100 from regions 205 and 207 as shown, the user is afforded the mechanical advantage of the device's lever action. Accordingly, a person who is suffering from a lack of strength (e.g., a frail, elderly person) will find the task of pill splitting using the present invention to be much easier than normal due to the described lever action.

FIGS. 4 and 5 provide a perspective view of bottom portion 103. As shown, the region that holds a pill in place during the cutting operation is comprised of a bottom surface 401, a first holding arm 403 and a second holding arm 405. Surface 401 in combination with arms 403 and 405 form an approximately triangularly shaped region. Although such a shape is not required, it aids in holding a pill 501, illustrated in FIG. 5, in place during the cutting operation. Additionally, surface 401 is preferably formed at a slight angle, thus helping to hold pill 501 in place, as shown, prior to the cutting operation.

In order to hold pill 501 in place during the cutting operation, preferably arms 403 and 405 are flexible. For example, arms 403 and 405 may only be rigidly fixed to portion 103 along a small region 407. Thus the majority of the arms are free to pivot. Accordingly, when the user places pill 501 between arms 403 and 405, the arms are outwardly flexed, i.e., away from one another. When the user releases the pill from their grasp, the inward force of the arms helps to maintain the pill in the desired location. Additionally, the flexibility of arms 403 and 405 helps to prevent pill slippage or damage during the cutting operation due to the insertion of the knife-edge and the lateral, outward movement of the resulting two pill portions.

In the preferred embodiment of the invention, surface 401 includes a slight crest 409 coincident with the edge of cutting member 201. Preferably a slight gap remains between crest 409 and the edge of cutting member 201 upon closure of device 100. By providing an edge coincident with member 201, pressure is applied to both the top portion and the bottom portion of the pill along the same break line during the cutting operation, thus helping to achieve a clean cut. Crest 409 also provides a visual aid to the user in aligning the pill for cutting. In an alternate embodiment, surface 401 is flat. In another alternate embodiment, surface 401 includes a depression coincident with the edge of cutting member 201. In yet another alternate embodiment, surface 401 is shaped to form a crest, however, a depression is formed in the surface along crest line 409. In yet another alternate embodiment, surface 401 is shaped to form a slight trough, the trough centerline corresponding to the edge of the cutting member.

In the preferred embodiment of the invention, one or more surfaces are coated with an elastomer, preferably a thermoplastic elastomer such as Versaflex™ OM 1040X by GLS Corporation. The elastomer helps to prevent pill slippage during the cutting operation by providing a higher coefficient of friction than is otherwise obtained. Preferably the inwardly facing surfaces of arms 403 and 405 are coated with the elastomer as is surface 401. Although the full benefits of the elastomer coating can only be realized if both arms 403 and 405 as well as surface 401 are coated, it is understood that coating only a subset of these surfaces will still help to prevent pill slippage. In addition to being coated with an elastomer, preferably the inwardly facing surfaces of arms 403 and 405 are formed with a plurality of vertically oriented grooves or ridges 411. Grooves or ridges 411 further prevent pill slippage. Preferably grooves or ridges 411 are molded into arms 403 and 405 during fabrication.

In at least one embodiment of the invention, portion 101 or both portions 101 and 103 are fabricated from a transparent or semi-transparent material. Alternately only the section of portion 101 over region 105 or the section of portion 101 over region 107 is fabricated from a transparent or semi-transparent material. The advantage of having region 105 fabricated from a transparent or semi-transparent material is that the user is able to determine the number, if any, of pills held within device 100 without opening the device. The advantage of having region 107 fabricated from a transparent or semi-transparent material is that the user is able to monitor the cutting operation. If region 107 is not transparent or at least semi-transparent, without the user's knowledge the pill may move after it has been placed into position and prior to being cut. As a consequence, the pill may not be cut in accordance with the user's wishes, potentially leading to the user taking the wrong dosage or discarding the mis-cut pill portions. If region 107 is transparent or at least semi-transparent, the user is able to monitor the pill after positioning the pill and during device closure. If the pill moves prior to being cut, the user simply opens the device, re-positions the pill, and starts over. As a consequence, mis-dosage or waste can be avoided.

In an alternate embodiment, and assuming that at least the section of portion 101 corresponding to region 107 is transparent or semi-transparent, a magnifying lens element is included. The lens element is positioned over the cutting region to help the user correctly position the pill for cutting. The magnifying lens element can be formed into portion 101 during the part's fabrication. As such, portion 101 remains a single piece but includes the magnifying lens element. Alternately, the lens element can be affixed to this region of portion 101 with an optically transparent adhesive.

In yet another alternate embodiment, a section of portion 101 near the end opposite hinge member 209 is ridged, the ridges providing an improved user gripping surface. Preferably the ridges run parallel to the axis of hinge member 209. A corresponding section of portion 103 can also be similarly ridged.

It is understood that other configurations of the invention are envisioned. For example, in an alternate embodiment the positions of arms 403 and 405 can be reversed relative to hinge member 209 so that the pill, when in position for cutting, is closer to region 105 than hinge member 209. In another alternate embodiment, cutting member 201 and positioning arms 403 and 405 can be rotated 90 degrees such that the knife-edge is parallel rather than being perpendicular to the axis of hinge member 209. In yet another alternate embodiment, device 100 can include a spring mechanism, such as a leaf spring, that promotes device closure thus minimizing the risk of pills contained within region 105 falling out.

Accordingly and as will be understood by those familiar with the art, the present invention may be embodied in other specific forms without departing from the spirit or essential characteristics thereof. Therefore the disclosures and descriptions herein are intended to be illustrative, but not limiting, of the scope of the invention which is set forth in the following claims.

What is claimed is:

1. A pill splitting device comprising:
a lower member fabricated from a first material, said lower member further comprising:
a pill holding region comprised of a first surface, a first holding arm, and a second holding arm, wherein said first surface, first holding arm, and second holding arm are fabricated from said first material, wherein a first portion of said first holding arm is rigidly coupled to said lower member and a second portion of said first holding arm is flexibly coupled to said lower member via said first portion, and wherein a first portion of said second holding arm is rigidly coupled to said lower member and a second portion of said second holding arm is flexibly coupled to said lower member via said first portion; and
an elastomer applied to an inwardly facing surface of said first holding arm and to an inwardly facing surface of said second holding arm;
an upper member hingeably coupled to said lower member fabricated from said first material, wherein a portion of said upper member corresponding to said pill holding region of said lower member is transparent or semi-transparent; and
a cutting member affixed to said upper member.

2. The pill splitting device of claim 1, wherein said elastomer is applied to said first surface of said pill holding region.

3. The pill splitting device of claim 1, wherein a portion of said inwardly facing surface of said first holding arm is grooved and wherein a portion of said inwardly facing surface of said second holding arm is grooved.

4. The pill splitting device of claim 1, wherein a portion of said inwardly facing surface of said first holding arm is ridged and wherein a portion of said inwardly facing surface of said second holding arm is ridged.

5. The pill splitting device of claim 1, wherein said lower member further comprises a pill storage area.

6. The pill splitting device of claim 1, wherein said first material is transparent or semi-transparent.

7. The pill splitting device of claim 1, further comprising a magnifying lens element coupled to said upper member and corresponding to said pill holding region of said lower member.

8. A pill splitting device comprising:
a lower member fabricated from a first material, said lower member further comprising:
a pill holding region comprised of a first surface, a first holding arm, and a second holding arm, wherein said first surface, first holding arm, and second holding arm are fabricated from said first material, wherein a first portion of said first holding arm is rigidly coupled to said lower member and a second portion of said first holding arm is flexibly coupled to said lower member via said first portion, and wherein a first portion of said second holding arm is rigidly coupled to said lower member and a second portion of said second holding arm is flexibly coupled to said lower member via said first portion; and
an elastomer applied to said first surface of said pill holding region;
an upper member hingeably coupled to said lower member fabricated from said first material, wherein a portion of said upper member corresponding to said pill holding region of said lower member is transparent or semi-transparent; and
a cutting member affixed to said upper member.

9. The pill splitting device of claim 8, wherein said elastomer is applied to an inwardly facing surface of said first holding arm and to an inwardly facing surface of said second holding arm.

10. The pill splitting device of claim 8, wherein a portion of an inwardly facing surface of said first holding arm is grooved and wherein a portion of an inwardly facing surface of said second holding arm is grooved.

11. The pill splitting device of claim 8, wherein a portion of an inwardly facing surface of said first holding arm is ridged and wherein a portion of an inwardly facing surface of said second holding arm is ridged.

12. The pill splitting device of claim 8, wherein said lower member further comprises a pill storage area.

13. The pill splitting device of claim 8, wherein said first material is transparent or semi-transparent.

14. The pill splitting device of claim 8, further comprising a magnifying lens element coupled to said upper member and corresponding to said pill holding region of said lower member.

15. A pill splitting device comprising:
a lower member fabricated from a first material, said lower member further comprising:
a pill holding region comprised of a first surface, a first holding arm, and a second holding arm, wherein said first surface, first holding arm, and second holding arm are fabricated from said first material; and
an elastomer applied to an inwardly facing surface of said first holding arm and to an inwardly facing surface of said second holding arm;
an upper member hingeably coupled to said lower member fabricated from said first material, wherein a portion of said upper member corresponding to said pill holding region of said lower member is transparent or semi-transparent; and
a cutting member affixed to said upper member.

16. The pill splitting device of claim 15, wherein said elastomer is applied to said first surface of said pill holding region.

17. The pill splitting device of claim 15, wherein a portion of said inwardly facing surface of said first holding arm is grooved and wherein a portion of said inwardly facing surface of said second holding arm is grooved.

18. The pill splitting device of claim 15, wherein a portion of said inwardly facing surface of said first holding arm is ridged and wherein a portion of said inwardly facing surface of said second holding arm is ridged.

19. The pill splitting device of claim 15, wherein said lower member further comprises a pill storage area.

20. The pill splitting device of claim 15, wherein said first material is transparent or semi-transparent.

21. The pill splitting device of claim 15, further comprising a magnifying lens element coupled to said upper member and corresponding to said pill holding region of said lower member.

22. A pill splitting device comprising:
a lower member fabricated from a first material, said lower member further comprising:
a pill holding region comprised of a first surface, a first holding arm, and a second holding arm, wherein said first surface, first holding arm, and second holding arm are fabricated from said first material; and
an elastomer applied to said first surface of said pill holding region;
an upper member hingeably coupled to said lower member fabricated from said first material, wherein a portion of said upper member corresponding to said pill holding region of said lower member is transparent or semi-transparent; and
a cutting member affixed to said upper member.

23. The pill splitting device of claim 22, wherein said elastomer is applied to an inwardly facing surface of said first holding arm and to an inwardly facing surface of said second holding arm.

24. The pill splitting device of claim 22, wherein a portion of an inwardly facing surface of said first holding arm is grooved and wherein a portion of an inwardly facing surface of said second holding arm is grooved.

25. The pill splitting device of claim 22, wherein a portion of an inwardly facing surface of said first holding arm is ridged and wherein a portion of an inwardly facing surface of said second holding arm is ridged.

26. The pill splitting device of claim 22, wherein said lower member further comprises a pill storage area.

27. The pill splitting device of claim 22, wherein said first material is transparent or semi-transparent.

28. The pill splitting device of claim 22, further comprising a magnifying lens element coupled to said upper member and corresponding to said pill holding region of said lower member.
